(19) United States
(12) Patent Application Publication
(10) Pub. No.: US 2004/0218530 A1
(43) Pub. Date: Nov. 4, 2004

(54) Maximization of data transmission via multiple links in the presence of crosstalk

(75) Inventors: Eli Magal, Givataim (IL); Zeev Oster, Modiin (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: SPEDIANT SYSTEMS LTD.

(21) Appl. No.: 10/425,632

(22) Filed: Apr. 30, 2003

(51) Int. Cl. H04L 12/26

(52) U.S. Cl. 370/235; 370/252

(57) ABSTRACT

A system and method for transmitting data streams subject to crosstalk, in which an adjustable parameter, preferably data rate, is adjusted using feedback of performance characteristics, preferably signal-to-noise ratio (SNR) and line attenuation, maximizing total throughput of the data streams. The invention is particularly applicable to inverse multiplex (IMUX) systems, where total throughput is more important than the throughput of any individual data stream.

### FIELD AND BACKGROUND OF THE INVENTION

The present invention relates to a system for transmitting data streams via multiple links in the presence of crosstalk, and more particularly to a system that uses feedback to optimize the transmission rates of a group of communication links that are subject to crosstalk so as to maximize the overall data transmission rate, subject to transmission quality constraints.

As used herein, the term “crosstalk” means the coupling of a portion of a signal transmitted via a communication link to another communication link.

As used herein, the term “unacceptable crosstalk” means crosstalk that causes performance of a communication link to be poorer than the performance specified for that communication link.

A system for optimizing the transmission rates of a group of communication links which are subject to crosstalk, as provided by the present invention, is of particular value in inverse multiplex data transmission systems, although such a system for optimizing transmission rates is also applicable to other types of communication systems that are subject to crosstalk. The application of the system of the present invention for optimizing transmission rates to inverse multiplex systems is included in the scope of the present invention. The application of the system of the present invention for optimizing transmission rates to other communication systems that are subject to crosstalk is included in the scope of the present invention.

In an inverse multiplexing system, multiple data links are joined together in parallel to form a single aggregate link whose total data transmission capacity is close to or equal to the sum of the data transmission capacities of the individual links.

At the transmitter, an inverse multiplexing system must divide the data stream into separate data streams, one for each of the links being used, while the receiver must recombine the several streams to recover the original data stream. See co-pending U.S. patent application Ser. No. 10/335872, which is incorporated by reference for all purposes as if fully set forth herein.

As used herein, the term “symbol”, as applied to a digital communication link, means the basic unit of information transmitted by that communication link.

In some links, for example, RS-232, a symbol is a single bit, while in others, for example, QAM, a symbol includes more than one bit. The information may be carried by amplitude, frequency, phase, other signal phenomena, or combinations thereof.

When communication links, such as those including twisted wire pairs, are in close physical proximity to each other, they are subject to the coupling of signals from one link to another, a phenomenon known as “crosstalk”. By adding an unwanted signal to a link, crosstalk degrades the performance of that link. For example, in an analog telephone system, crosstalk can make a conversation on another line be audible, interfering with conversation. In a digital system, crosstalk can change signals received by a receiver sufficiently to cause the receiver to mistake one symbol for another, increasing the bit error rate (BER) of the link.

As larger numbers of links are concentrated in a limited space, the problem of crosstalk worsens.

As an example, consider a cable that includes several twisted pairs. If only a single one of the twisted pairs is in use, there is no problem of crosstalk among the twisted pairs. This allows the link to operate using modulation techniques that transmit many bits per symbol, but are very sensitive to interference. If another of the twisted pairs is activated, crosstalk between these two pairs may reduce the number of bits per symbol that either link can carry for any particular BER.

If several communication links that are subject to crosstalk are started at the same time, it is possible that some will suffer unacceptable levels of crosstalk. If the links are started one after the other, the links started early in the process will begin to suffer more and more crosstalk as other links are started. A mechanism for adjusting the data rates of individual communication links to allow a combination of data rates that maximizes total throughput of such a system would be highly desirable, especially in inverse multiplex data transmission systems, because the total data rate for the communication links is more important than the data rate for any individual communication link in inverse multiplex data transmission systems.

There is thus a widely recognized need for, and it would be highly advantageous to have, a system for transmitting data streams via multiple links in the presence of crosstalk that optimizes the transmission rates of the communication links so as to maximize the overall data transmission rate, subject to transmission quality constraints.

### SUMMARY OF THE INVENTION

According to the present invention there is provided a system for transmitting data streams that are subject to crosstalk, including: (a) a plurality of communication links, each communication link having a respective performance characteristic, at least one of the communication links having an adjustable parameter; (b) a mechanism for measuring the performance characteristics; and, (c) a mechanism for adjusting the one or more adjustable parameters in response to the mechanism for measuring the performance characteristics.

According to the present invention there is provided a method for transmitting data streams via a plurality of communication links that are subject to crosstalk, the method including the steps of: (a) providing: (i) a mechanism for measuring a respective performance characteristic of each of the communication links; and, (ii) a mechanism for adjusting a respective adjustable parameter of at least one of the communication links; (b) transmitting a signal via at least one of the communication links in accordance with the adjustable parameter thereof; (c) measuring the respective performance characteristic of at least one of the communication links; and, (d) if one of the one or more performance characteristic is outside of a respective preselected range, adjusting the one or more adjustable parameters until every one of the one or more performance characteristics is inside the preselected range thereof.

Preferably, the communication links include digital communication links.

Preferably, the at least one adjustable parameter includes a data transmission rate.

Preferably, the performance characteristics include signal-to-noise ratios.

Preferably, the performance characteristics include line attenuations.

Alternatively, the performance characteristics include bit error rates.

Preferably, the communication links include communication links of an inverse multiplex data transmission system.

Preferably, each communication link has an adjustable parameter, and the system is operative to adjust all the adjustable parameters.

Preferably, the system further includes: (d) a controller operative to set an initial value of an adjustable parameter to a value unlikely to induce unacceptable crosstalk.

Alternatively, the system further includes: (d) a memory operative to store a value of at least one of the one or more adjustable parameters; and (e) a controller operative to set an initial value of an adjustable parameter based on a value thereof stored in the memory.

Turning now to the method of the present invention, preferably, in the transmitting step, two or more respective signals are transmitted via corresponding communication links, substantially simultaneously.

Preferably, each of the one or more adjustable parameters includes a data transmission rate.

Preferably, the performance characteristics include signal-to-noise ratios.

Preferably, the performance characteristics include line attenuations.

Alternatively, the performance characteristics include bit error rates.

Preferably, each communication link has an adjustable parameter, and all the adjustable parameters are adjusted to bring every one of the one or more performance characteristics within the preselected range thereof.

Preferably, the method further includes the step of: (e) selecting an initial value, of each adjustable parameter, that is unlikely to induce unacceptable crosstalk.

Alternatively, the method further includes the step of: (e) storing a respective value of one of the one or more adjustable parameters.

Preferably, the method further includes the step of: (f) upon starting the system, initializing an adjustable parameter based on a corresponding stored value thereof.

If several communication links that are subject to crosstalk are started at the same time, it is possible that some will suffer unacceptable levels of crosstalk. If the links are started one after the other, the links started early in the process will begin to suffer more and more crosstalk as other links are started. A feedback mechanism, as provided by the present invention, can be used to adjust the data rates of the individual communication links to allow a combination of data rates that maximizes total throughput of such a system. This mechanism is especially applicable to inverse multiplex data transmission systems, because the total data rate for communication links is more important than the data rate for any individual communication link in such a system.

The present invention successfully addresses the shortcomings of the presently known systems for transmitting data streams via multiple links in the presence of crosstalk by providing a system that uses feedback of information regarding the quality of data transmission via individual links in the presence of crosstalk to guide the selection of transmission speeds for the individual links so as to optimize total data throughput for the collection of links.

### BRIEF DESCRIPTION OF THE DRAWINGS

The invention is herein described, by way of example only, with reference to the accompanying drawings, wherein:

FIG. 1 is a schematic illustration of a system for transmitting data streams via multiple links according to the present invention;

FIG. 2 is a flowchart illustrating the process of establishing link data rates for a preferred embodiment of the present invention.

### DESCRIPTION OF THE PREFERRED EMBODIMENTS

The present invention is of a communication system having a plurality of communication links that addresses the problem of crosstalk between the communication links by adjusting transmission parameters of the communication links according to feedback of performance parameters of the communication links. This invention is particularly applicable to an inverse multiplexing system that can be used to transmit a single data stream via multiple links, making optimal use of the available transmission capacity.

The principles and operation of a system for transmitting data streams via multiple links according to the present invention may be better understood with reference to the drawings and the accompanying description.

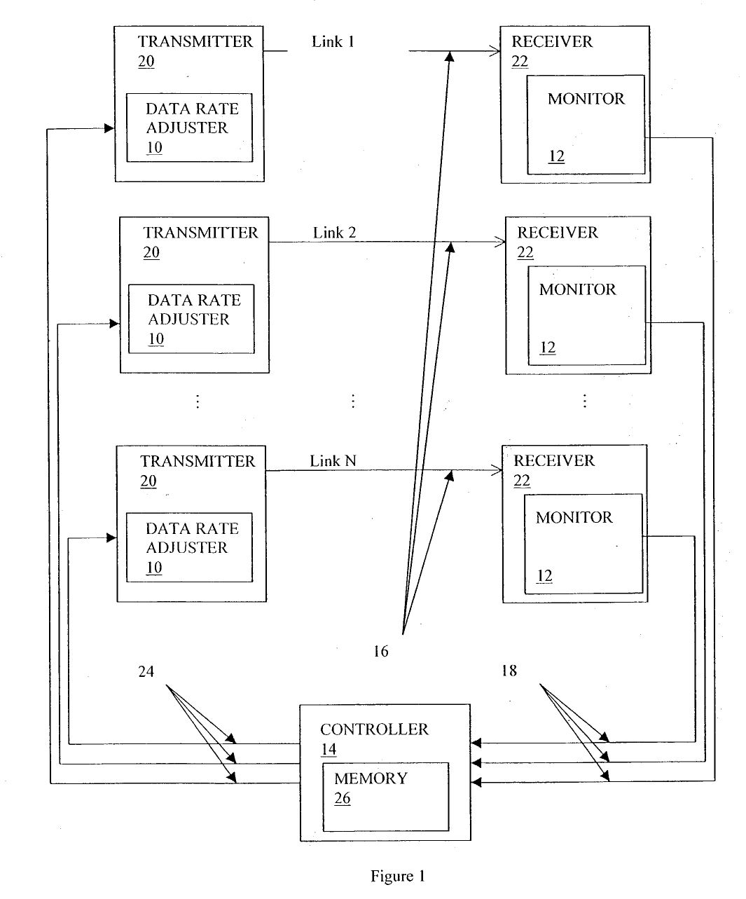

Referring now to the drawings, FIG. 1 is a schematic illustration of a preferred embodiment of a system for transmitting data streams via multiple links according to the present invention.

The system in FIG. 1 includes a collection of independent communication subsystems, each independent communication subsystem including a respective transmitter 20, a respective link 16, and a respective receiver 22. Links 16 may be subject to crosstalk. Each transmitter 20 includes a respective data rate adjuster 10. Each receiver 22 includes a respective monitor 12, operative to measure at least one performance characteristic. In this preferred embodiment, the performance characteristics measured include signal-to-noise ratio (SNR) and line attenuation. In a variation of this preferred embodiment, the performance characteristics measured include the bit error rate (BER). The monitor 12 may be implemented in hardware or software or a combination thereof. Respective feedback paths 18 are operative to transmit information about performance characteristics from monitors 12 to a controller 14. Controller 14 is operative to transmit commands, including commands for the data rate adjusters 10, to transmitters 20, via control paths 24. A variation of this preferred embodiment includes a memory 26 that is operative to store values of data rates at which links 16, or links of other, comparable communication systems, have operated with acceptable levels of crosstalk in the past, and controller 14 selects initial values for setting data rate adjusters 10 from values stored in memory 26. Although memory 26 is shown in FIG. 1 as being internal to controller 14, part or all of memory 26 may, alternatively, be external to controller 14. Such use of a memory 26 is included in the scope of the present invention.

Although, for simplicity, the discussion here centers mostly on transmission of data in a single direction, it will be clear to those skilled in the art that similar considerations apply to bidirectional transmission of data. Bidirectional transmission of data is included in the scope of the present invention.

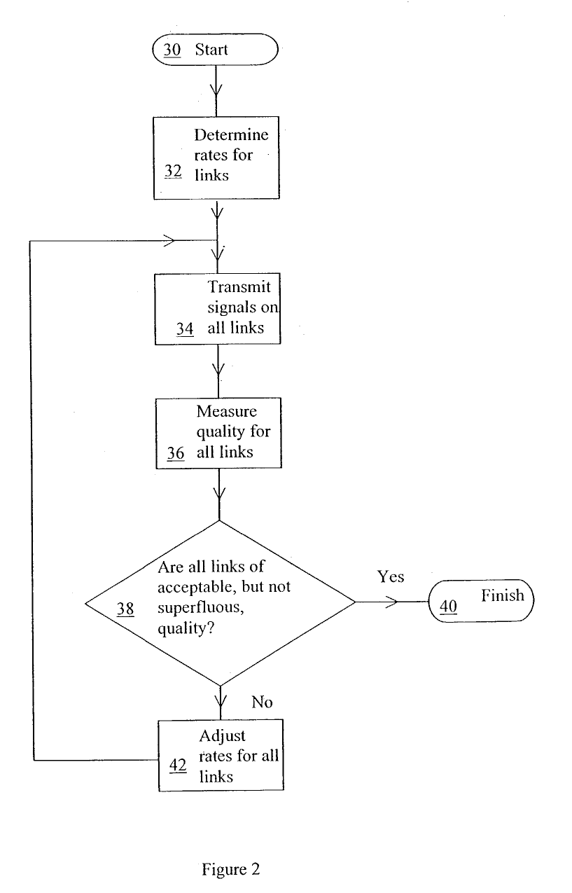

FIG. 2 is a flowchart illustrating the process of establishing link data rates for a preferred embodiment of the present invention.

This preferred embodiment may be better understood by following the process illustrated in the flowchart of FIG. 2. Beginning at the start box 30, control passes to a process 32 labeled “Determine rates for links”. In process 32, an adjustable parameter that has an influence on the level of crosstalk between links, such as data rate or signal power, is chosen for each link 16. The preferred adjustable parameter is the data rate for each link 16. There are many different ways to select these data rates, all of which are within the scope of the present invention. One way is to select a respective low data rate for each link 16, so that crosstalk is minimal during the initial phase of establishment of data rates for links 16. Another way is to select respective data rates based upon historical data collected during past operation of the system or comparable systems initializing each link 16 with a respective data rate at which that link 16, or comparable links of this or other systems, have transmitted data successfully. Memory 26 is used to store these historical data.

Control next passes to a process 34 labeled “Transmit signals on all links”. In process 34, each transmitter 20 transmits a respective signal, which may include test data or other test signals, such as sinewaves, via its link 16, to be received by a respective receiver 22.

Although, in this preferred embodiment of the present invention, only test data are used during the startup procedure, it may be desirable in some situations, such as file transfers, to include payload data during the startup procedure. Payload data that are successfully transmitted, as determined by well-known methods such as cyclic redundancy checks, during the startup procedure may be used as payload data by the end-user of the system, while payload data that are not successfully received may be retransmitted, as is commonly done in systems that transmit data via imperfect links. Such use of payload data for testing quality of transmission via links 16 allows the transmission system to be used by the end-user of the system for the transmission of payload data sooner than would be possible if payload data are sent only after the transmission system is fully operational at optimum data rates, although data transmission during startup may be significantly slower than the optimum rate during this phase of operation. The use of payload data for testing quality of transmission via links 16 is included in the scope of the present invention.

Control next passes to a process 36 labeled “Measure quality for all links”. In this process 36 one or more performance characteristics, such as SNR and line attenuation, are measured for each link 16.

Control next passes to a decision block 38 labeled “Are all links of acceptable, but not superfluous, quality?”. If the performance characteristics for all links are at least at a lower threshold, but not above an upper threshold, the transmission rates of the communication links are optimal, control passes to finish box 40, the initialization process is completed, and the system is ready to transmit payload data.

If the condition of decision block 38 is not met, control passes to a process 42 labeled “Adjust rates for all links”.

If the performance characteristic for any link 16 is below a lower threshold, new data rates for the several links 16 are selected, preferably lower data rates.

Note that, if the performance characteristics of all links 16 are at least at the lower threshold, then if the performance characteristic of any link 16 is above the upper threshold, it probably is possible to transmit data at an even higher rate on that link 16. Because, for some data transmission protocols, including Single-pair High bit-rate Digital Subscriber Line (SHDSL), transmitting data at a higher rate mostly introduces energy at higher frequencies than those found in the transmission of data at a lower data rate, without substantially increasing the energy content of lower frequencies, and the respective receiver 22 corresponding to each respective link 16 filters out energy content at frequencies higher than those necessary for operation at the data rate of the respective link 16, increasing the data rate of a link 16 does not substantially increase crosstalk caused by that link 16 impinging upon other links 16 operating at lower data rates.

Therefore, for those links 16 whose performance characteristic is above the upper threshold, the system of the present invention selects a new data rate increased by an amount that preferably depends on how much beyond the upper threshold the performance characteristic is. Preferably, the amount of the data rate increase for these links 16 is limited to the increase that would be chosen for the poorest-performing of the above-threshold links 16. As an example, assume that a link 16 performing 3 dB above threshold can probably have its data rate increased by 1 megabit per second (1 Mbps), and that a link 16 performing 6 dB above threshold can have probably have its data rate increased by 2 Mbps. If one link 16 is found to be performing 3 dB above threshold, and a second link 16 is found to be performing 6 dB above threshold, then, in this preferred embodiment, it is preferred that, in this step, the new data rate selected for both the first link 16 and the second link 16 represent an increase of 1 Mbps.

Control then passes back to the process 34 labeled “Transmit data on all links”.

The measurement of performance characteristics of all links 16 and adjustment of data rates are repeated, cyclically, until an optimal combination of data rates for all communication links 16 is found.

While the invention has been described with respect to a limited number of embodiments, it will be appreciated that many variations, modifications and other applications of the invention may be made.

What is claimed is:

1. A system for transmitting data streams that are subject to crosstalk, comprising:
(a) a plurality of communication links, each said communication link having a respective performance characteristic, at least one said communication link having an adjustable parameter;
(b) a mechanism for measuring said performance characteristics; and,
(c) a mechanism for adjusting said at least one adjustable parameter in response to said mechanism for measuring said performance characteristics.

2. The system of claim 1, wherein said communication links include digital communication links.

3. The system of claim 1, wherein said at least one adjustable parameter includes a data transmission rate.

4. The system of claim 1, wherein said performance characteristics include signal-to-noise ratios.

5. The system of claim 1, wherein said performance characteristics include line attenuations.

6. The system of claim 1, wherein said performance characteristics include bit error rates.

7. The system of claim 1, wherein said communication links include communication links of an inverse multiplex data transmission system.

8. The system of claim 1, wherein each said communication link has an adjustable parameter, and wherein the system is operative to adjust all said adjustable parameters.

9. The system of claim 1, further comprising:
(d) a controller operative to set an initial value of a said adjustable parameter to a value unlikely to induce unacceptable crosstalk.

10. The system of claim 1, further comprising:
(d) a memory operative to store a value of at least one said at least one adjustable parameter; and
(e) a controller operative to set an initial value of a said adjustable parameter based on a value thereof stored in said memory.

11. A method for transmitting data streams via a plurality of communication links that are subject to crosstalk, the method comprising the steps of:
(a) providing:
(i) a mechanism for measuring a respective performance characteristic of each of the communication links; and,
(ii) a mechanism for adjusting a respective adjustable parameter of at least one of the communication links;
(b) transmitting a signal via at least one of the communication links in accordance with said adjustable parameter thereof;
(c) measuring said respective performance characteristic of at least one of the communication links; and,
(d) if a said at least one performance characteristic is outside of a respective preselected range, adjusting said at least one adjustable parameter until every said at least one performance characteristic is inside said preselected range thereof.

12. The method of claim 11, wherein said transmitting includes transmitting respective signals via at least two of the communication links, substantially simultaneously.

13. The method of claim 11, wherein each said at least one adjustable parameter includes a data transmission rate.

14. The method of claim 11, wherein said performance characteristics include signal-to-noise ratios.

15. The method of claim 11, wherein said performance characteristics include line attenuations.

16. The method of claim 11, wherein said performance characteristics include bit error rates.

17. The method of claim 11, wherein each said communication link has an adjustable parameter, and wherein all said adjustable parameters are adjusted to bring every said at least one performance characteristic within said preselected range thereof.

18. The method of claim 11, further comprising the step of:
(e) selecting an initial value, of each said adjustable parameter, that is unlikely to induce unacceptable crosstalk.

19. The method of claim 11, further comprising the step of:
(e) storing a respective value of said at least one adjustable parameter.

20. The method of claim 19, further comprising the step of:
(f) upon starting the system, initializing a said adjustable parameter based on a corresponding said stored value thereof.
